(19) United States
(12) Patent Application Publication
(10) Pub. No.: US 2018/0137464 A1
(43) Pub. Date: May 17, 2018

(54) APPARATUS, SYSTEM AND METHOD FOR PROVIDING A DESIGN FOR EXCELLENCE ENGINE

(71) Applicant: Jonpaul Patrick Hansen, St. Petersburg, FL (US)

(72) Inventor: Jonpaul Patrick Hansen, St. Petersburg, FL (US)

(73) Assignee: Jabil Circuit, Inc., St. Petersburg, FL (US)

(21) Appl. No.: 15/353,356

(22) Filed: Nov. 16, 2016

(51) Int. Cl. G06Q 10/10

(52) U.S. Cl. CPC G06Q 10/101; H04L 63/02

(57) ABSTRACT

The disclosed apparatus, system and method is and includes non-transitory computing code executed by at least one computing processor from at least one computing memory, for providing: a DfX engine for optimizing at least one design; a third party software interface associated with the DfX engine for receiving information from third party software, including third party design information relevant to the design; at least one database, comprising historical data of prior runs of the DfX engine related to the design, and comprising access to historical third party design information previously received at the third party software interface, communicatively associated with the DfX engine; and an analytics tool communicative with the DfX engine for calculating at least feedback of at least supply metrics, analytics, data mining, and historical data.

### BACKGROUND

### Field of the Disclosure

The disclosure relates generally to collaborative software tools and, more particularly, to an apparatus, system and method for providing a design for excellence engine.

### Description of the Background

A key aspect of the product development and realization process is the robustness of the product design. Efforts to improve design robustness have led to “Design for” initiatives, such as Design for Assembly (DfA), Design for Cost (DfC), Design for Manufacturing (DfM), Design for Test (DfT), Design for Logistics (DfL), Design for Performance (DfP), etc., which are collectively sometimes referred to as Design for Excellence (DfX).

A fundamental requirement for DfX is having a clear set of customer-driven requirements as the basis for product development. The “X” in DfX is also generally indicative of a variable or variables that may affect these customer-driven requirements. Such variables may include, by way of non-limiting example: manufacturability, power, variability, cost, yield, and reliability.

Thus, DfX includes a wide array of specific design guidelines to address the foregoing and other variables. Each design guideline may address a given issue that is caused by the needs for, or that affects the traits of, a product. The design guidelines endeavor to apply technical knowledge to methodologies that control, improve, or create particular traits of the product.

More specifically, DfX methodologies address the issues that may occur in one or more phases of a product life cycle. These phases include: the development phase; the production phase; the use phase; and the disposal phase.

Thus, reporting in relation to DfX methodologies is vital with respect to product development and actualization that accounts for all phases of product life cycle. However, such reports have historically typically had little or no standardization or traceability. For example, there is typically no way to track mitigation and communication of DfX issues and results among collaborators, in part because of the lack of database tracking of DfX results, which results in the inability to derive metrics and analytical data from past DfX results. Moreover, existing DfX reporting tools fail to provide sufficient levels of interactivity or security.

Therefore, the need exists for an apparatus, system and method of providing a DfX reporting tool, interface, and engine that allows for mitigation and traceability, such as on-line mitigation and traceability, and that allows for significant interactivity and security, particularly on-line.

### SUMMARY

The disclosed apparatus, system and method is and includes non-transitory computing code executed by at least one computing processor from at least one computing memory, for providing: a DfX engine for optimizing at least one design; a third party software interface associated with the DfX engine for receiving information from third party software, including third party design information relevant to the design; at least one database, comprising historical data of prior runs of the DfX engine related to the design, and comprising access to historical third party design information previously received at the third party software interface, communicatively associated with the DfX engine; and an analytics tool communicative with the DfX engine for calculating at least feedback of at least supply metrics, analytics, data mining, and historical data. The feedback may be calculated in accordance with: the third party design information; the historical data of prior runs of the DfX engine; the historical third party design information; and user-entered information received at a user interface communicatively associated with the DfX engine.

Thus, the disclosure provides at least an apparatus, system and method for providing a DfX reporting tool, interface, and engine that allows for mitigation and traceability, such as on-line mitigation and traceability, and that allows for significant interactivity and security, particularly on-line.

### BRIEF DESCRIPTION OF THE DRAWINGS

The exemplary compositions, systems, and methods shall be described hereinafter with reference to the attached drawings, which are given as non-limiting examples only, and in which:

FIG. 1 is an illustration of a system according to the embodiments;

FIG. 2 is a dashboard and reporting view according to the embodiments;

FIG. 3 is a dashboard and reporting view according to the embodiments;

FIG. 4 is a dashboard and reporting view according to the embodiments;

FIG. 5 is a dashboard and reporting view according to the embodiments;

FIG. 6 is a dashboard and reporting view according to the embodiments;

FIG. 7 is a dashboard and reporting view according to the embodiments

FIG. 8 is a dashboard and reporting view according to the embodiments;

FIG. 9 is a dashboard and reporting view according to the embodiments;

FIG. 10 is a dashboard and reporting view according to the embodiments;

FIG. 11 is a dashboard and reporting view according to the embodiments;

FIG. 12 is a dashboard and reporting view according to the embodiments;

FIG. 13 is a dashboard and reporting view according to the embodiments;

FIG. 14 is a dashboard and reporting view according to the embodiments;

FIG. 15 is a dashboard and reporting view according to the embodiments; and

FIG. 16 is an illustration of a computing system according to the embodiments.

### DETAILED DESCRIPTION

The figures and descriptions provided herein may have been simplified to illustrate aspects that are relevant for a clear understanding of the herein described apparatuses, systems, and methods, while eliminating, for the purpose of clarity, other aspects that may be found in typical similar devices, systems, and methods. Those of ordinary skill may thus recognize that other elements and/or operations may be desirable and/or necessary to implement the devices, systems, and methods described herein. But because such elements and operations are known in the art, and because they do not facilitate a better understanding of the present disclosure, for the sake of brevity a discussion of such elements and operations may not be provided herein. However, the present disclosure is deemed to nevertheless include all such elements, variations, and modifications to the described aspects that would be known to those of ordinary skill in the art.

Embodiments are provided throughout so that this disclosure is sufficiently thorough and fully conveys the scope of the disclosed embodiments to those who are skilled in the art. Numerous specific details are set forth, such as examples of specific components, devices, and methods, to provide a thorough understanding of embodiments of the present disclosure. Nevertheless, it will be apparent to those skilled in the art that certain specific disclosed details need not be employed, and that embodiments may be embodied in different forms. As such, the embodiments should not be construed to limit the scope of the disclosure. As referenced above, in some embodiments, well-known processes, well-known device structures, and well-known technologies may not be described in detail.

The terminology used herein is for the purpose of describing particular embodiments only and is not intended to be limiting. For example, as used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The steps, processes, and operations described herein are not to be construed as necessarily requiring their respective performance in the particular order discussed or illustrated, unless specifically identified as a preferred or required order of performance. It is also to be understood that additional or alternative steps may be employed, in place of or in conjunction with the disclosed aspects.

When an element, process, system, engine or layer is referred to as being “on”, “upon”, “connected to” or “coupled to” another element, process, system, engine or layer, it may be directly on, upon, connected or coupled to the other element, process, system, engine or layer, or intervening elements, processes, systems, engines or layers may be present, unless clearly indicated otherwise. In contrast, when an element, process, system, engine or layer is referred to as being “directly on,” “directly upon”, “directly connected to” or “directly coupled to” another element, process, system, engine or layer, there may be no intervening elements, processes, systems, engines or layers present. Other words used to describe the relationship between elements should be interpreted in a like fashion (e.g., “between” versus “directly between,” “adjacent” versus “directly adjacent,” etc.). Further, as used herein the term “and/or” includes any and all combinations of one or more of the associated listed items.

Yet further, although the terms first, second, third, etc. may be used herein to describe various elements, processes, systems, engines, layers and/or sections, these aspects should not be limited by these terms. These terms may be only used to distinguish one element, process, system, engine, layer or section from another element, process, system, engine, layer or section. Terms such as “first,” “second,” and other numerical terms when used herein do not imply a sequence or order unless clearly indicated by the context. Thus, a first element, process, system, engine, layer or section discussed below could be termed a second element, process, system, engine, layer or section without departing from the teachings of the embodiments.

The exemplary embodiments provide a streamlined process for DFX reporting, mitigation, and traceability in, for example, a Web interface or similar online interface. The provided tools and encompassing software engine may communicate with a variety of reporting and request/ordering systems, and may include one or more tools and databases that supply and allow for the supply of metrics, analytics, data mining, and historical data mining for product projects through, for example, a dashboard provided over the aforementioned online interface. Accordingly, the exemplary embodiments may allow for creation of a report and a shared review of results as between multiple entities within the product development cycle through an online and interactive interconnection. For example, a customer and a contract engineer may communicate regarding satisfaction of customer criteria and design rules during the engineering development process in the embodiments, wherein the customer may be provided with secure access to the disclosed reporting mechanisms even from outside a firewall of the contract engineer, such as through the online interface. Thereby, all entities involved in the product design and development may be enabled to analyze data and formulate responses to the data, or to changes therein, in real time.

Likewise, the disclosed engine allows for the use of current and prior collaborations, and historical feedback of successful and failing remedial and mitigation efforts in product design and development efforts, to be used in current DfX efforts. Detailed data regarding particulars of such remedial and mitigation efforts, the issues addressed, and the particular parts, products, or contexts also allow for expanded use of this automated feedback in relation to current efforts for designs not having immediately evident applicability to past efforts. As such, the disclosed engine may evaluate and bypass issues for new, updated, and past products in development, either for the current user's efforts or, if the current user is so-authorized, for the efforts of other or all users.

In part, the foregoing may be provided by a standardized DfX reporting tool provided within the disclosed engine. This standardization ensures products are designed to meet all relevant design requirements, from any source and in any format, and/or are subject to forward- and reverse-looking mitigation plans for items that do not or may not meet the requirements. Uniform and standardized reports improve readability to, reaction by, and traceability of activity of, all users. Further, the standardization allows interaction by the engine with other platforms and/or operating systems (OS). Thereby, the quality and effectiveness of feedback reported from the engine is enhanced so that design issues may be resolved or mitigated faster and more efficiently.

This standardized access may be securely provided in an online interface. The security measures may include encryption and/or portaled access only by authorized parties, and only to the information authorized for a particular party. Accordingly, all parties, regardless of the entity with which each party is associated, may have interactive access to the engine via, for example, the aforementioned Web-based front end.

Through this front end, historical database data and present design-rules may be directly accessible to design and engineering groups, wherein either or both may be outside of a firewall. Collaboration, communication, and reports may also occur securely in real time within this front-end interface. And all such data, collaboration, communication and reporting may be traced via the interaction through and with the front-end interface, which traceability is unavailable in the known art.

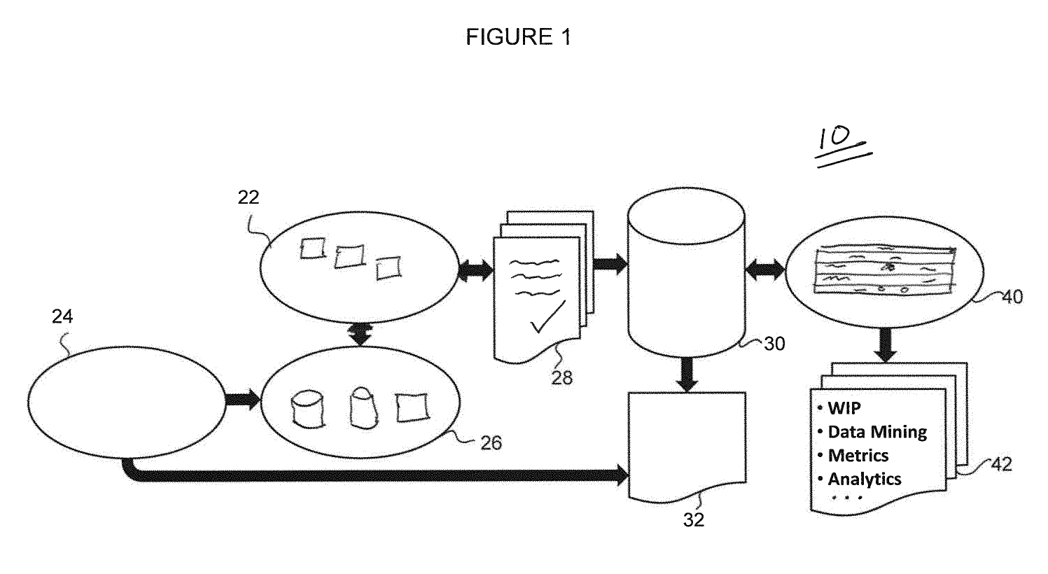

More specifically, the block diagram of FIG. 1 illustrates an exemplary embodiment of a system 10 in which the tools, i.e., software code acting as a tool, within engine 22, i.e., software code acting as an engine, are interconnected with one or more business or engineering software systems 24 that provide a knowledge base 26 from which the disclosed tools and engine 22 can draw. DfX results 28 may be tracked though the provided tool and engine 22, and the tracked results may be stored and/or otherwise made available within a web-available database 30 or databases. This database or databases may further include data from the aforementioned business and engineering systems 32.

As an aspect of the system 10, the dashboard 40, such as an online Web-based front end for a SQL database that is available continuously or semi-continuously, in whole or in part, for authorized users as discussed above, may be provided. The dashboard 40 may provide a variety of analytics tools, datamining, both current and historical, metrics, work-in-process tracking, search capabilities, and the like 42, to allow for management of the DfX process using the dashboard. The dashboard may be available via an online tool that provides secure access to the aforementioned database, analytics, and data discussed herein.

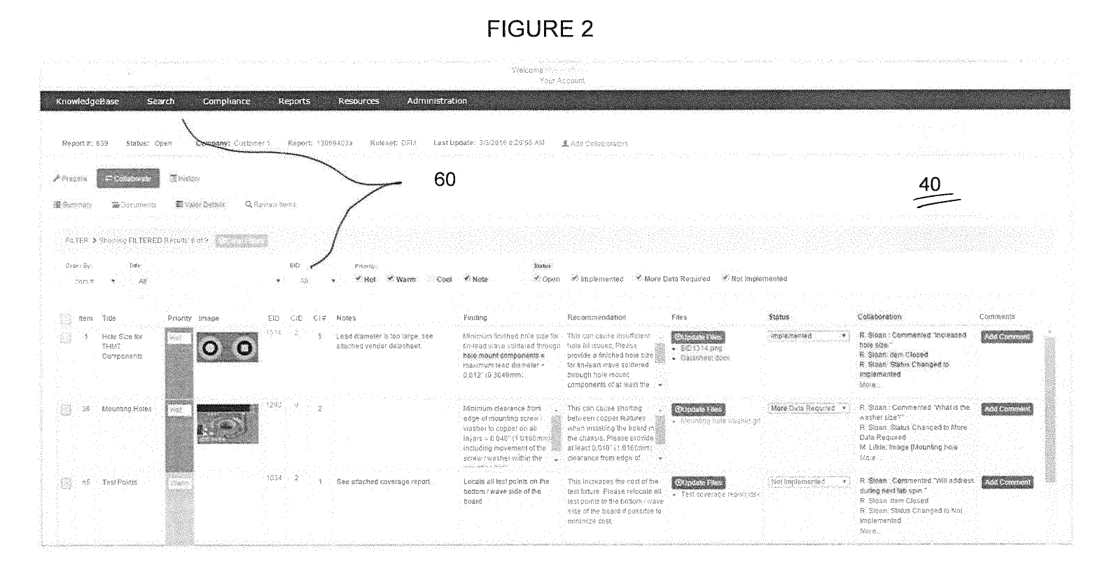

FIG. 2 is an exemplary illustration of a dashboard 40 accessible to a user of the disclosed tool and engine. As illustrated, filtering and searching 60 may be performed that allow a user to view results that are deemed important by the user in a format preferred by the user. Further, and as shown in FIG. 2, each task may be given a title, a priority, and may have other relevant data associated therewith. Such other data may include, for example: identifying information; pictures, data, documents, etc. of in-process developments; collaborative or unilateral notes and findings regarding certain processes and tasks, and recommendations and collaboration notes regarding those tasks; any additional data or document files to be associated with a given task; issues associated with the task; a status of the task; and the capability to add or view comments regarding certain tasks.

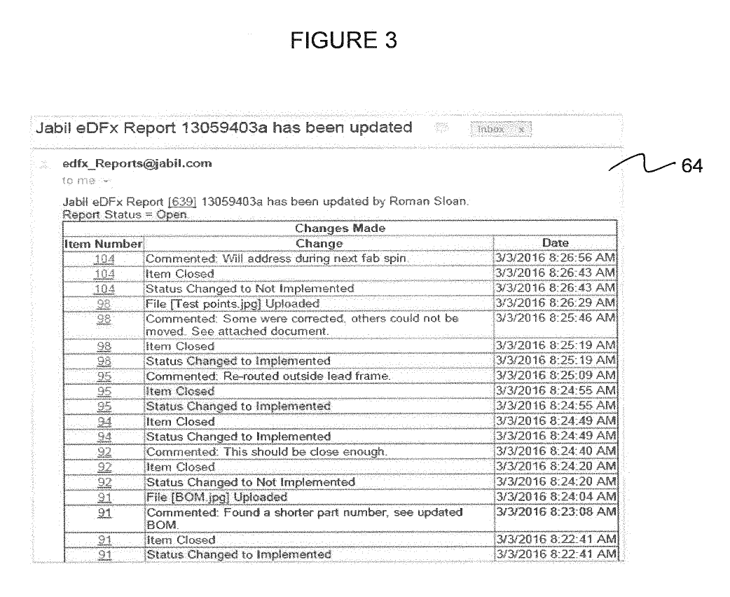

FIG. 3 is an illustration of a notification 64, such as a report update notification, which may be external to (such as may occur via email, text, SMS, MMS, or the like) the dashboard, or which may “spring” from the dashboard, for example, indicating that a report has been created, published, or updated, or the like. This notification may issue at the direction of an authorized user within the dashboard 40, or may automatically issue upon a triggering event (which may be based on a design event or milestone, or based on a user action or inaction, for example), by way of example. Moreover, an alert or message such as that illustrated in FIG. 3 may include links, such as hyperlinks, that allow for secure access to the dashboard and/or that may take the user directly to the report or a specific item noted from the report.

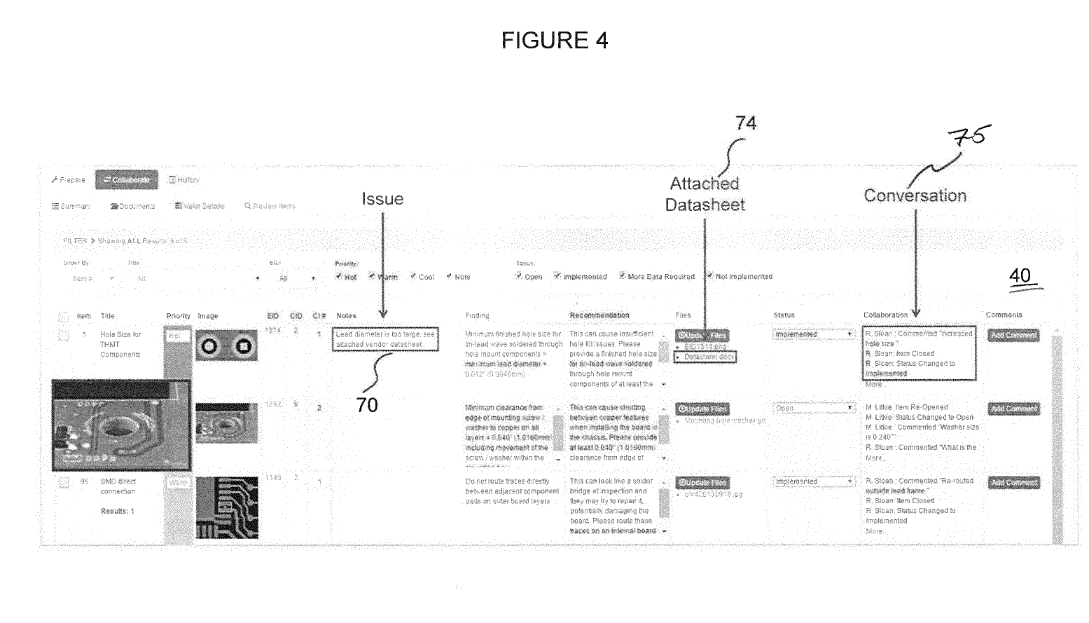

The engine 22 provided thus reduces the time to produce a report, and may make the report, such as including past, present, and projected feedback, available to relevant entities, as well as indicating any issues within the report, including prospective mitigation techniques for such issues, any chronic nature of such issues, and the time needed to resolve such issues. The engine 22 thus allows for improvements in quality, consistency, and effectiveness, both of DfX product development and of collaboration between relevant entities. This is readily illustrated in FIG. 4, in which the dashboard 40 displays an issue 70, an attached data sheet that includes information that is presumptively relevant to the issue 74, and an ongoing conversation related to that same issue 75, wherein the issue 70 is relevant to a particular task in the product development cycle.

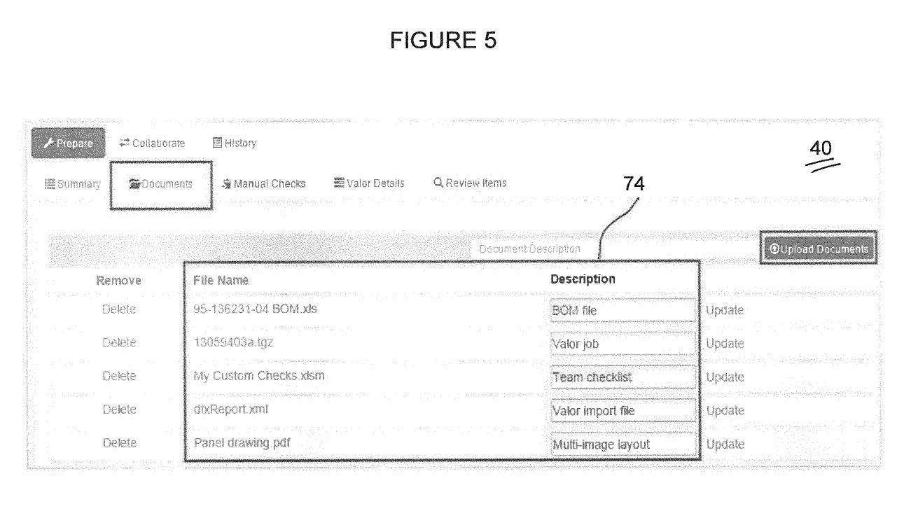

FIG. 5 illustrates with particularity the association of data and documents 74 with particular tasks, and accessibility of those documents from within the dashboard 40. In the illustration, documents have also been attached to the report that may have been generated by external business and/or engineering systems relevant to the task selected, such as discussed hereinabove with respect to FIG. 1.

That is, by way of non-limiting example, a user is provided with the ability to insert images or attach files, including external or third party software files, to help explain a given issue. Moreover, relevant product data and information, such as from other platforms or systems (such as CAD systems, etc.) may be stored within the report in association with a given task and/or issue.

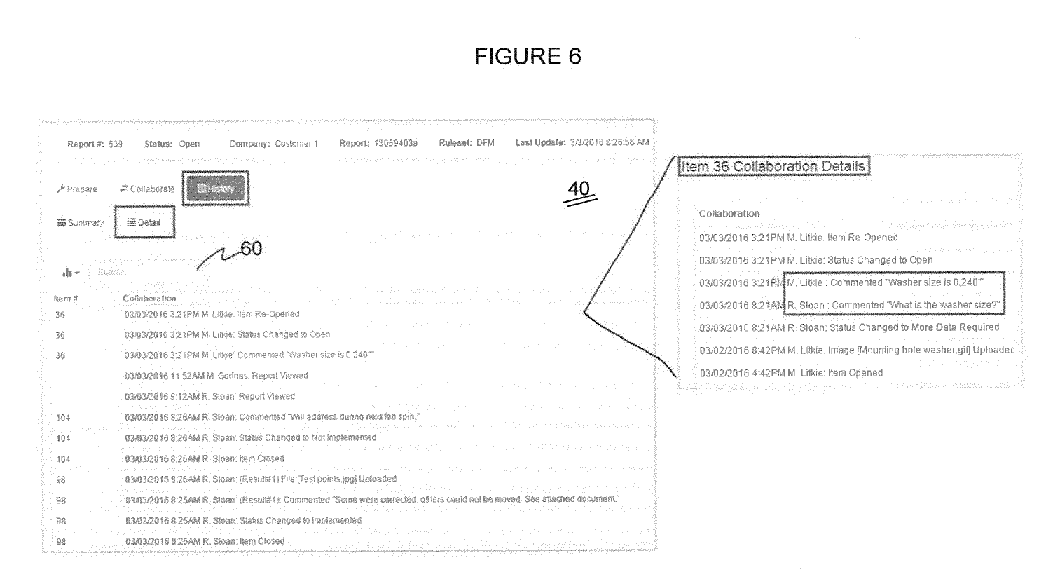

As discussed above, the availability of historical tasks, issues, and mitigations with regard to tasks in product development may allow for avoidance of “reinventing the wheel” when it comes to problems that have been solved in other related tasks or developments of similar product aspects, and additionally allows for a reporting of who, what, where, and when in each aspect of the product design and development cycle. The relatedness may be assessed, for example, using a sliding scale of relatedness based on keywords, verticals, parts used, etc., as between different designs. The who, what, where, and when may additionally include associated collaborations and comments for every action on each issue and task in a report displayed within the dashboard, and thus may additionally contribute to the assessment of relatedness of designs. This is illustrated in the example of FIG. 6. Also indicated in FIG. 6 is the availability of search 60 in the above-referenced data.

The foregoing may thus serve to provide either automatically triggered or manually requested feedback, as referenced above. By way of example, the actual findings, tasks, documents, comments, collaborations, and mitigations in reports stored in database(s) 30 may be used to look for trends within business units, by product, by product aspect/part, by customer, and/or by chronic violation of particular requirements. This information may also indicate a particular mitigation, such as based on historical success or failure of certain mitigations in similar circumstances. The disclosed system 10 may accordingly track a variety of statistics across projects to measure the effectiveness of the feedback provided by the system, including but not limited to: who performed the review, when, what product, what customer, issues reported, customer response, issues resolved, issue closure rates, repeat issues from earlier reports, third party reports and data imported, etc. As referenced above, this information may also be manually filterable and searchable.

Also as discussed throughout, certain of the foregoing information, data and feedback may solely be available to certain authorized users or entities, such as to provide enhanced security in the use of the embodiments. This enhanced security may be provided, by way of non-limiting example, by providing password or other encrypted access to the dashboard 40 or aspects thereof.

Security controls and data protection requirements may also be controlled at the user account level, the design level, the affiliated entity, the issue level, or at combinations thereof, such as based on user type, by way of non-limiting example, with the ability to view and access areas of the DfX results and corresponded uploaded data assigned on a global authorization or as-needed basis. External user access security controls and data protection requirements may differ from internal user protocols, such as wherein external user controls are controlled at the user account level with the ability to view and access areas of the DfX results and uploaded data only on an as-needed basis.

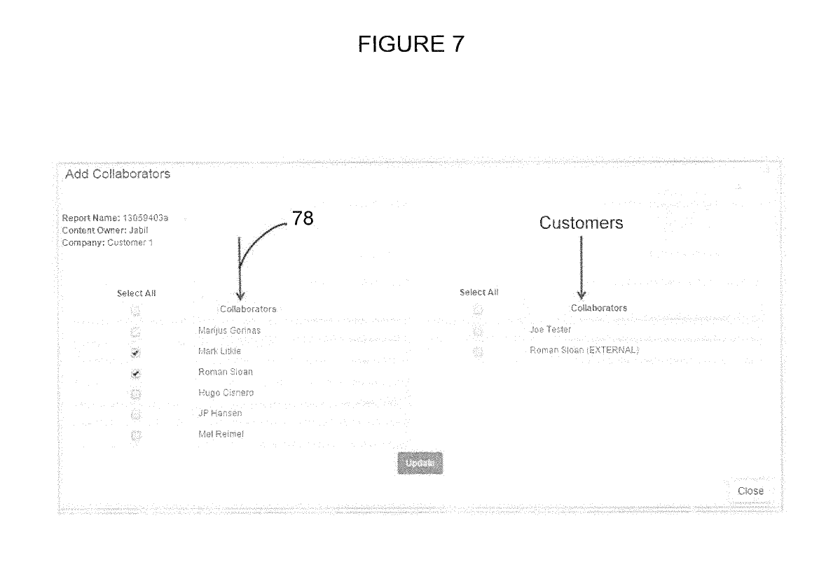

Similarly, controlled access may allow only for a predefined list of collaborators assigned to aspects of the report to access the report, or only particular aspects thereof. The addition of collaborators 78, and/or the selection of roles for each, is illustrated in the example of FIG. 7. Of note, control, access levels, and the like may be defined in accordance with the roles and assignments assigned to collaborators.

That is, feedback on DfX progress, mitigation, and report issues may be stored and/or otherwise available online, and the discussed collaboration feed may allow multiple external users and internal users to have back and forth conversations tied particularly to each DfX issue. Further, notifications, such as email notifications, may be sent when a report is created, published, modified, or an issue addressed or raised, both to internal and external authorized users having authorization on that design or aspects thereof. Such notifications may, for example, be configurable, such as via “subscriptions” to a report or to individual items in a report.

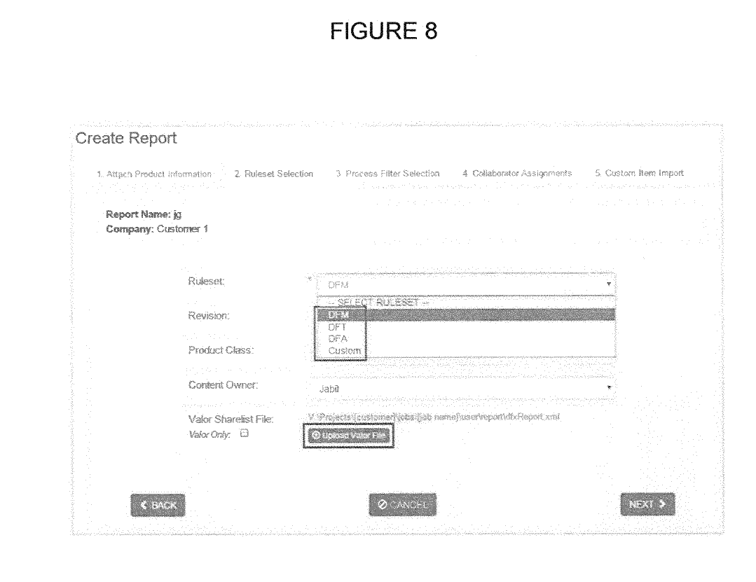

FIG. 8 is an exemplary illustration of aspects of a DfX chosen by a reviewer to be included in a given report. A report may include any of various combinations of DfX guidelines, as well as business and engineering custom rules or guidelines. In the illustration, the user may select DFM, DFT, DFA, or custom checks for inclusion in a DfX report.

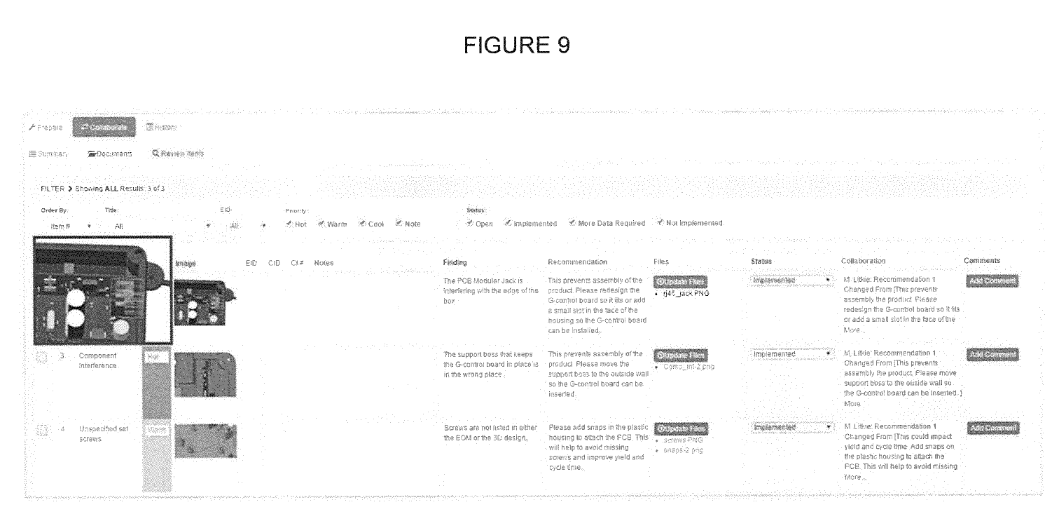

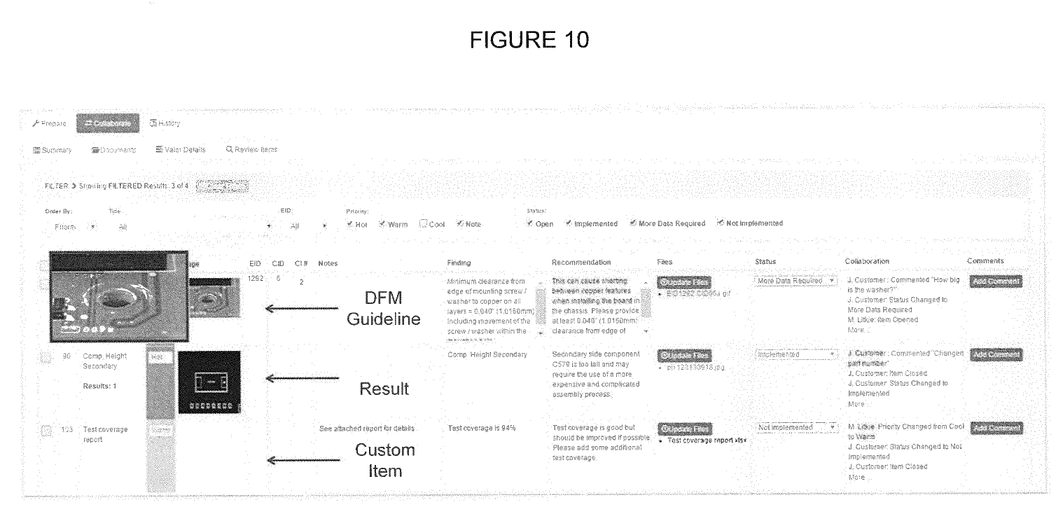

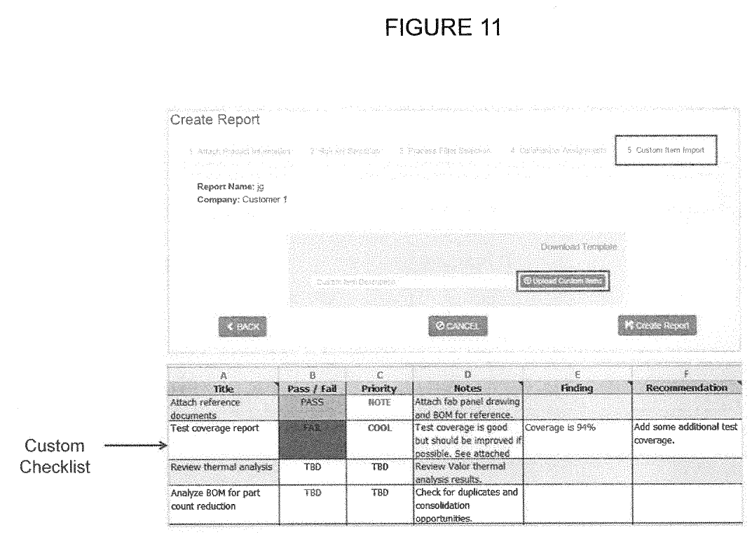

In accordance with the selection of particular aspects of a DfX for inclusion in a report, or for independent reporting, FIG. 9 illustrates an exemplary DFA report. The skilled artisan will appreciate, in light of the discussion herein, the similarities between the DFA report and an overall DfX report. FIG. 10 is an exemplary illustration of a DFM report, with the additional inclusion of custom aspects, such as from an associated engineering or business system as referenced in FIG. 1. FIG. 11 provides an exemplary illustration that allows a user to elect to import custom items from, for example, an Excel file to allow for maintenance within the dashboard of a custom checklist that is not otherwise provided in the DfX engine.

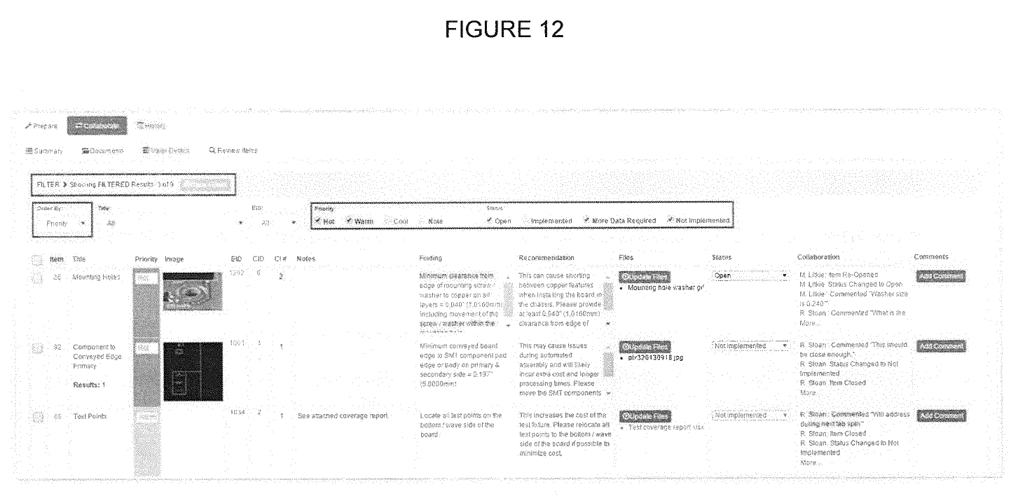

FIG. 12 again illustrates the ability for collaborators to filter and sort items as desired. This capability, provided in the exemplary embodiments, improves the ease with which a user may perform a review of a report and a response thereto, as well as the ease with which a collaborator can “issue spot” regarding aspects of particular interest to that collaborator.

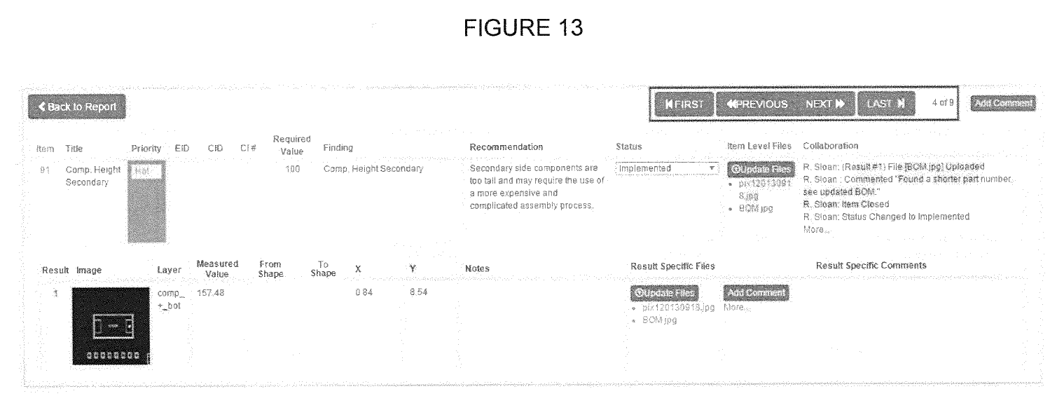

Likewise, FIG. 13 illustrates a view in which reviewers may specifically review particular items in a single-item view. This single-item view may allow for highlighting of particular pieces of information that are highly relevant to the single issue then under view. Thereby, collaborators having particular interest in only a given issue or issues may be enabled by the DfX tool to focus on those issues. Moreover, the single item view may provide additional modes in relation to the item under view, such as a “step through” mode that may allow a user to step through items in single view, i.e., using arrows to move to the next or previous item, while still in single item view.

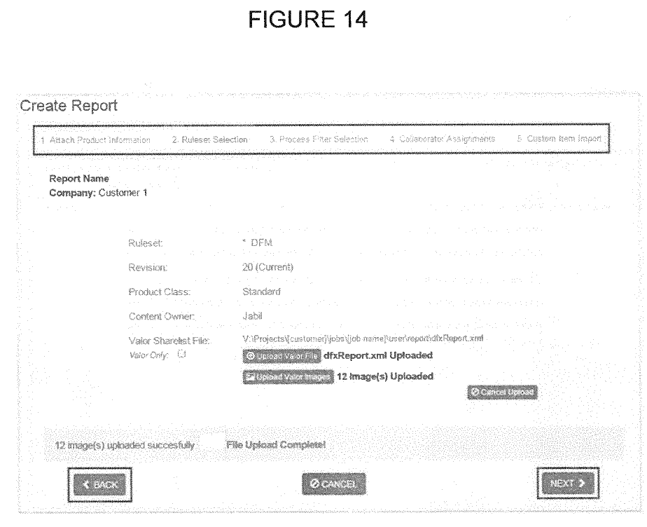

Of course, not only may the DfX engine allow for customization, but it may also provide for standardization of DfX reviews. FIG. 14 illustrates a standardized report view, in which a standardized report may be provided to reduce the variability of information provided to different reviewers.

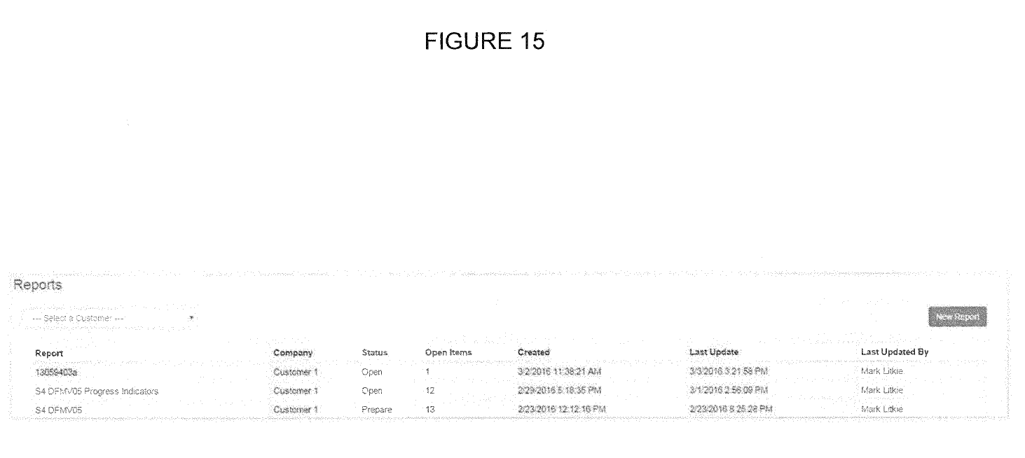

The central location provided by the DfX dashboard and database improves the efficiency with which results can be compared from previous reviews, and learnings applied from previous reviews and previous product developments to the current product development and current reporting. Needless to say, this allows for the pulling of repeat issues, and the resolutions related thereto, from earlier reports into a current report, in order to save review time from earlier reports to a current report, such as in order to not only save time but also improve process issue resolution. That is, having all global DfX reports in a single place in a single database or databases provides a holistic history of issues and resolutions that may be leveraged to measure the overall effectiveness of design reviews, design improvements, and improvements to the global knowledge database. Moreover, this holistic overview of issues and solutions allows for the compiling of a variety of statistics to measure the effectiveness of resolution and mitigation efforts, and the DfX tools and engine 22 overall, including but not limited to: who performed a review and when, what customer the review related to, what product the review related to, the issues that were reported and resolved, repeat issues in a single product development or across multiple product developments, collaboration comments and responses, issue closure rates, external business and engineering process usage and issue resolutions, average time of development per task and per report, and the like. This is further illustrated with regard to the example of FIG. 15.

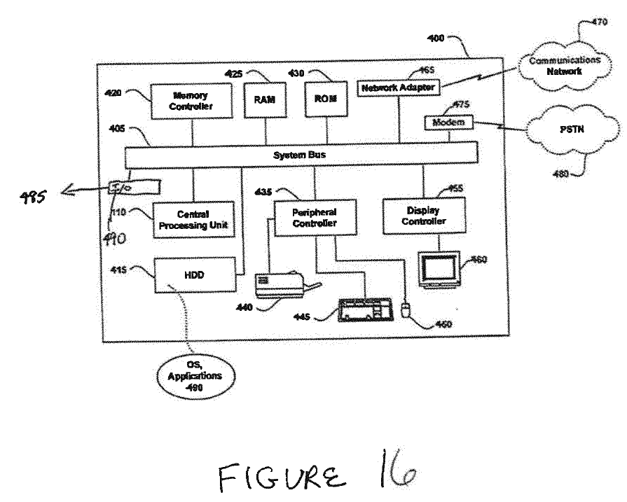

FIG. 16 illustrates an exemplary embodiment of a computer processing system 400 that may be operably employed in embodiments discussed herein, and that may perform the processing and logic discussed throughout. That is, the exemplary computing system 400 is just one example of a system that may be used in accordance with herein described systems and methods.

Computing system 400 is capable of executing software, such as an operating system (OS) and one or more computing applications 490. The software may likewise be suitable for operating and/or monitoring hardware, such as via inputs/outputs (I/O), using said applications 490.

The operation of exemplary computing system 400 is controlled primarily by computer readable instructions, such as instructions stored in a computer readable storage medium, such as hard disk drive (HDD) 415, optical disk (not shown) such as a CD or DVD, solid state drive (not shown) such as a USB “thumb drive,” or the like. Such instructions may be executed within central processing unit (CPU) 410 to cause computing system 400 to perform the disclosed operations. In many known computer servers, workstations, PLCs, personal computers, mobile devices, and the like, CPU 410 is implemented in an integrated circuit called a processor.

The various illustrative logics, logical blocks, modules, and engines, described in connection with the embodiments disclosed herein may be implemented or performed with any of a general purpose CPU, a digital signal processor (DSP), an application specific integrated circuit (ASIC), a field programmable gate array (FPGA) or other programmable logic device, discrete gate or transistor logic, discrete hardware components, or any combination thereof, respectively acting as CPU 410. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is appreciated that, although exemplary computing system 400 is shown to comprise a single CPU 410, such description is merely illustrative, as computing system 400 may comprise a plurality of CPUs 410. Additionally, computing system 100 may exploit the resources of remote or parallel CPUs (not shown), for example, through local or remote communications network 470 or some other data communications means.

In operation, CPU 410 fetches, decodes, and executes instructions from a computer readable storage medium, such as HDD 415. Such instructions can be included in the software, such as the operating system (OS), executable programs/applications, and the like. Information, such as computer instructions and other computer readable data, is transferred between components of computing system 400 via the system's main data-transfer path. The main data-transfer path may use a system bus architecture 405, although other computer architectures (not shown) can be used, such as architectures using serializers and deserializers and crossbar switches to communicate data between devices over serial communication paths.

System bus 405 may include data lines for sending data, address lines for sending addresses, and control lines for sending interrupts and for operating the system bus. Some busses provide bus arbitration that regulates access to the bus by extension cards, controllers, and CPU 410. Devices that attach to the busses and arbitrate access to the bus are called bus masters. Bus master support also allows multiprocessor configurations of the busses to be created by the addition of bus master adapters containing processors and support chips.

Memory devices coupled to system bus 405 can include random access memory (RAM) 425 and read only memory (ROM) 430. Such memories include circuitry that allows information to be stored and retrieved. ROMs 430 generally contain stored data that cannot be modified. Data stored in RAM 425 can generally be read or changed by CPU 410 or other communicative hardware devices. Access to RAM 425 and/or ROM 430 may be controlled by memory controller 420. Memory controller 420 may provide an address translation function that translates virtual addresses into physical addresses as instructions are executed. Memory controller 420 may also provide a memory protection function that isolates processes within the system and that isolates system processes from user processes. Thus, a program running in user mode can normally access only memory mapped by its own process virtual address space; it cannot access memory within another process' virtual address space unless memory sharing between the processes has been set up.

The steps and/or actions described in connection with the aspects disclosed herein may be embodied directly in hardware, in a software module executed by a processor, or in a combination of the two, in communication with memory controller 420 in order to gain the requisite performance instructions. That is, the described software modules to perform the functions and provide the directions discussed herein throughout may reside in RAM memory, flash memory, ROM memory, EPROM memory, EEPROM memory, registers, a hard disk, a removable disk, a CD-ROM, or any other form of storage medium known in the art. Any one or more of these exemplary storage medium may be coupled to the processor 410, such that the processor can read information from, and write information to, that storage medium. In the alternative, the storage medium may be integral to the processor. Further, in some aspects, the processor and the storage medium may reside in an ASIC. Additionally, in some aspects, the steps and/or actions may reside as one or any combination or set of instructions on an external machine readable medium and/or computer readable medium as may be integrated through I/O port(s) 485, such as a “flash” drive.

In addition, computing system 400 may contain peripheral controller 435 responsible for communicating instructions using a peripheral bus from CPU 410 to peripherals and other hardware, such as printer 440, keyboard 445, and mouse 450. An example of a peripheral bus is the Peripheral Component Interconnect (PCI) bus.

One or more hardware input/output (I/O) devices 485 may be in communication with hardware controller 490. This hardware communication and control may be implemented in a variety of ways and may include one or more computer busses and/or bridges and/or routers. The I/O devices controlled may include any type of port-based hardware (and may additionally comprise software, firmware, or the like), and can also include network adapters and/or mass storage devices from which the computer system 400 can send and receive data for the purposes disclosed herein. The computer system 400 may thus be in communication with the Internet or other networked devices/PLCs via the I/O devices 485 and/or via communications network 470.

Display 460, which is controlled by display controller 455, may optionally be used to display visual output generated by computing system 400. Display controller 455 may also control, or otherwise be communicative with, the display. Visual output may include text, graphics, animated graphics, and/or video, for example. Display 460 may be implemented with a CRT-based video display, an LCD-based display, gas plasma-based display, touch-panel, or the like. Display controller 455 includes electronic components required to generate a video signal that is sent for display.

Further, computing system 400 may contain network adapter 465 which may be used to couple computing system 400 to an external communication network 470, which may include or provide access to the Internet, and hence which may provide or include tracking of and access to the process data discussed herein. Communications network 470 may provide access to computing system 400 with means of communicating and transferring software and information electronically, and may be coupled directly to computing system 400, or indirectly to computing system 400, such as via PSTN or cellular network 480. Additionally, communications network 470 may provide for distributed processing, which involves several computers and the sharing of workloads or cooperative efforts in performing a task. It is appreciated that the network connections shown are exemplary and other means of establishing communications links between multiple computing systems 400 may be used.

It is appreciated that exemplary computing system 400 is merely illustrative of a computing environment in which the herein described systems and methods may operate, and thus does not limit the implementation of the herein described systems and methods in computing environments having differing components and configurations. That is, the concepts described herein may be implemented in various computing environments using various components and configurations.

Further, the descriptions of the disclosure are provided to enable any person skilled in the art to make or use the disclosed embodiments. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but rather is to be accorded the widest scope consistent with the principles and novel features disclosed herein.

What is claimed is:

1. A DfX system, comprising non-transitory computing code executed by at least one computing processor from at least one computing memory, comprising:
a DfX engine for optimizing at least one design;
a third party software interface associated with the DfX engine for receiving information from third party software, including third party design information relevant to the design;
at least one database, comprising historical data of prior runs of the DfX engine related to the design, and comprising access to historical third party design information previously received at the third party software interface, communicatively associated with the DfX engine;
an analytics tool communicative with the DfX engine for calculating at least feedback of at least supply metrics, analytics, data mining, and historical data in accordance with:
the third party design information;
the historical data of prior runs of the DfX engine;
the historical third party design information; and
user-entered information received at a user interface communicatively associated with the DfX engine.

2. The DfX system of claim 1, wherein the third party software comprises business process software.

3. The DfX system of claim 1, wherein the third party software comprises engineering software.

4. The DfX system of claim 1, wherein the user interface comprises a Web interface.

5. The DfX system of claim 4, wherein the Web interface comprises a dashboard.

6. The DfX system of claim 1, wherein the feedback comprises an electronic report.

7. The DfX system of claim 6, wherein each aspect of the electronic report is traceable.

8. The DfX system of claim 6, further comprising a collaboration tool, wherein results of the electronic report are shared in the collaboration tool.

9. The DfX system of claim 8, wherein the sharing comprises collaboration between internal and external users.

10. The DfX system of claim 9, wherein the sharing is across at least one firewall.

11. The DfX system of claim 1, wherein the feedback further comprises at least one issue mitigation.

12. The DfX system of claim 1, further comprising a standardization tool.

13. The DfX system of claim 12, wherein the standardization is across at least platforms, operating systems, source files, and file formats.

14. The DfX system of claim 1, wherein the feedback is reverse-looking.

15. The DfX system of claim 1, wherein the feedback is backward-looking.

16. The DfX system of claim 1, further comprising at least one secured interface to the user interface.

17. The DfX system of claim 16, wherein the security comprises at least one of encryption and portaled access.

18. The DfX system of claim 16, wherein the security comprises at least limited authorized access.

19. The DfX system of claim 1, wherein the relatedness of the historical data to the prior runs of the DfX engine comprises a scaled assessment.

20. The DfX system of claim 1, wherein the user interface comprises a single item view.
